(19) United States
(12) Patent Application Publication
(10) Pub. No.: US 2015/0211728 A1
(43) Pub. Date: Jul. 30, 2015

(54) SHOWERHEAD

(71) Applicants: Eli Zhadanov, Brooklyn, NY (US); Sam Zhadanov, Brooklyn, NY (US)

(72) Inventors: Eli Zhadanov, Brooklyn, NY (US); Sam Zhadanov, Brooklyn, NY (US)

(21) Appl. No.: 14/164,918

(22) Filed: Jan. 27, 2014

(51) Int. Cl. F21V 33/00; B05B 1/18

(52) U.S. Cl. CPC F21V 33/004; B05B 1/185

(57) ABSTRACT

A showerhead has a hollow housing connectable with a source of water, a cover that covers said housing and is provided with a plurality of outlet openings through which water passing through the housing issues in form of water jets, and a light source arranged in the housing and generating light which issues from the showerhead only through local transparent portions of the cover that are closely adjacent to the outlet openings and separated from each other by non-transparent portions of the cover.

### BACKGROUND OF THE INVENTION

The present invention relates to bathroom accessories and in particular to showerheads for issuance of water for showering by users.

A known showerhead is usually an article that is connectable to a source of water and is provided with a plurality of outlet openings through which water, after passing through the showerhead, issues outwardly towards a user in form of individual jets. It has been also known to provide showerheads with means for illumination of the area of showering, for example to assist users in orientation of their bodies in a shower and relative to the issuing water. For this purpose a light source was arranged in the interior of the showerhead, and the perforated cover plate provided with the outlet openings for forming water jets was made transparent as a whole. As a result, simultaneously with issuance of water from the showerhead through a plurality of the outlet openings in form of the individual jets, a single beam of light generated by the interior light source was passing through the whole area of the transparent cover plate in direction towards the user.

While in this construction the objective of illumination of the area of water issuing from the showerhead was achieved, this approach has certain disadvantages. In view of the fact that the whole or a large portion of cover plate is transparent, a user of such showerhead sees the interior of the showerhead, which usually holds remaining water and accommodates a plurality of mechanical components, and as a result can develop an unpleasant feeling that he/she sees old unclean water and is using a complicated and unsafe device. In addition, the unusual appearance of such device is different from conventionally accepted showers, thereby making it less acceptable for a consumer to purchase and use. It is therefore believe that the existing showerheads of this type can be further improved to hide their inner elements and to make them more conventional in appearance.

### SUMMARY OF THE INVENTION

Accordingly, it is an object of the present invention to provide a showerhead which is a further improvement of existing showerheads.

In keeping with these objects and with others which will become apparent hereinafter, one feature of the present invention resides, briefly stated, in a showerhead which has a housing connectable to a source of water, a cover that covers said housing and is provided with a plurality of outlet opening through which water passing through said housing issues in form of water jets, a light source arranged in an interior of said housing and generating light, wherein said cover is provided with a plurality of local transparent portions at least some of which are each adjacent to at least one of said outlet openings and separated from other transparent portions by non-transparent portions, so that the light generated by said light source exits said housing only through said local transparent portions which can surround said outlet openings and thereby can surround said water jets.

When the showerhead is designed in accordance with the present invention, only the local portions of the cover element which are adjacent to or surround the water jets are transparent and allow passage of the water jets through their interior outwardly of the cover and also passage of light through them from the interior of the showerhead outwardly of the latter, thus performing a double function, while the remaining portions of the cover are non-transparent, and thereby a user using such showerhead cannot see its interior.

In accordance with a further feature of the present invention, the transparent portions of the cover element are circular and circumferentially surround the outlet openings of the cover element of the showerhead.

In accordance with a further feature of the present invention, the cover is composed of an outer non-transparent element provided with a plurality of openings and an inner element which is transparent and is provided with a plurality of transparent hollow projections which are inserted in the openings of the outer element and form said local transparent portions.

In accordance with another feature of the present invention, in the inner element the transparent hollow projections of one group are flexible and extend outwardly beyond the outer non-transparent element, while a remaining portion of the inner element is rigid.

In accordance with a further feature of the present invention, in the inner element the transparent hollow projections of another group are rigid.

In accordance with still further feature of the present invention, the outer surface of the outer element is light-reflective.

The novel features of the present invention are set forth in particular in the appended claims.

The invention itself however both as to its construction and its manner of operation , will be best understood from the following description of the preferred embodiments which is accompanied by the following drawings.

### BRIEF DESCRIPTION OF THE DRAWINGS

FIG. 1 is a front view of an outer element of a cover of a showerhead in accordance with the present invention;

FIG. 2 is a front view of an inner element of the cover of the showerhead in accordance with the present invention;

FIG. 3 is a front view of a light- emitting unit of the showerhead of the present invention;

FIG. 4 is a front view of a housing of the showerhead in accordance with the present invention;

FIG. 5 is a cross section of a transparent protrusion of one group of hollow protrusions of the inner element of the cover, inserted into an opening of the outer element;

FIG. 6 is a cross section of a transparent protrusion of another group of hollow protrusions of the inner element of the cover, inserted into an opening of the outer element; and

FIG. 7 is an exploded view of the showerhead in accordance with the invention, showing its components.

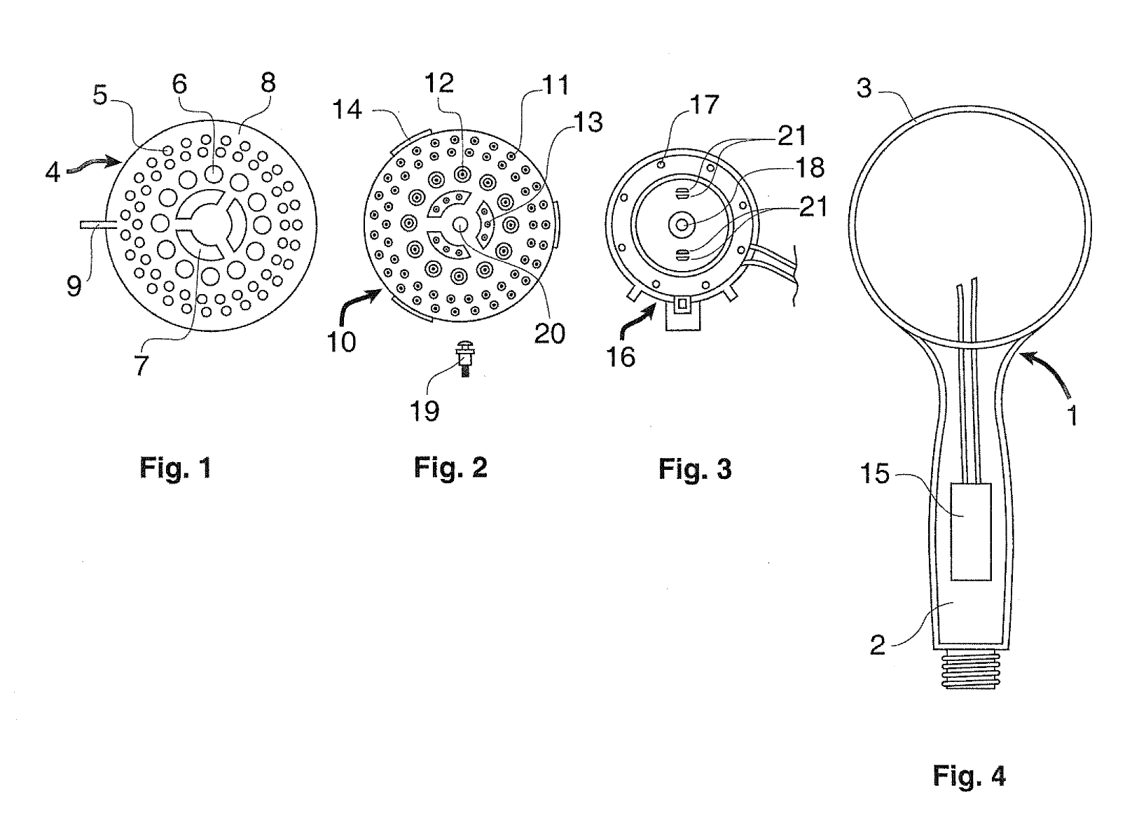

### DESCRIPTION OF THE PREFERRED EMBODIMENTS

A showerhead in accordance with the present invention has a housing which is identified with reference numeral 1 and has one end portion 2 connectable to a source of water, for example an outlet pipe or shower hose extending from a wall in a bathroom and the like, and another opposite end portion 3.

The end portion 3 of the housing 1 is closed by a cover including an outer plate-like element 4 provided with a plurality of through-going opening through which water jets are issued toward a user who wants to take a shower. In the shown exemplary embodiment the outer element 4 has a plurality of smaller radially outer openings 5, a plurality of larger central openings 6, and a few radially inner openings 7. The outer element 4 is non-transparent. Its outer surface 8 is made light-reflective for example, by a high-quality polishing, by applying a coating of a light-reflective material, etc. The outer element 4 is provided with a lever 9 for turning it around an axis

The cover of the showerhead further has an inner plate-shaped element 10 which is transparent and can be composed, for example of a transparent plastic. in the shown exemplary embodiment, the element 10 has a plurality of hollow projections 11 of a smaller diameter which can be tubular, a plurality of hollow projections 12 of a larger diameter which can be tubular, and a plurality of through-going openings 13 that can be arranged in zones. Each group of these projections and openings can be arranged in zones. Each group of these projections and openings can be used for a different water pattern. It also has several peripheral protrusions 14.

The showerhead in accordance with the present invention further has a light-generating assembly. It includes a light generator 15 located in the housing 1 and generating electric current for example under the action of water which passes through the housing 1. Such generators are known and a detailed description of ₜhe generator 15 is believed to be superfluous. The assembly further has a light-emitting unit 16 which has a central part that can accommodate a not shown circuit board and a peripheral area with a plurality of light sources, for example light-emitting diodes 17, and which is connected with the generator 15 by wires.

The central part of the light-emitting unit 16 has a central hole 18 for extending of a fastener 19 which also extends through a central hole 20 of the inner element 10 for connecting the components 10 and 16 with each other. The central part of the light-emitting unit 16 also has through-going openings 21 for a water flow from the housing 1 through the through-going openings 21 and further through the openings of the cover elements 10 and 4 outwardly of the showerhead.

To assemble the showerhead, the light- emitting unit 16 is connected with the inner element 10 by the fastener 19 which however allow turning of the inner element 10 together with the outer element 4 relative to the light-emitting unit 16 by the lever 9. The outer element 4 is snapped by its outer bent edge over the protrusions 14 of the inner element 10 so that the hollow projections 11 and 12 of the inner element 10 line up with and are inserted into the openings 5 and 6 of the outer element 4, and the assembly including the components 4, 10, and 16 is inserted into the concave end portion 3 of the housing 1 and held in the latter for example by a press-fit or additional not shown holding means.

When water is supplied into the end portion 2 of the housing 1, it flows through the housing to its end portion 3, then flows through the opening 21 of the light emitting unit 16, then flow through the interior of the hollow projections 11 and 12 and through the openings 13 of the inner element 10, and then flows outwardly of the corresponding openings 5, 6 and 7 of the outer element 4. During passage of the water through the housing 1 from its end portion 2 toward its end portion 3, the water operates the electrical generator 15 which supplies power to the light sources 17. The light sources 17 emit light which passes both through the transparent tubular projections 11 and 1.2 and zones containing openings 13 of the transparent inner element 10. When the water issues outwardly of the outer element 4 of the cover in form of water jets, the light issues through the transparent hollow projections 11 and 12 which are inserted in the openings 5 and 6, and circularly around the water jets. A portion of light issues through a radially inner part of the inner element 16 and then through the openings 7 of the outer element 4 simultaneously with the issuing water jets. Thus the light issues only in narrow local areas in the immediate proximity of the issuing water jets, while the major area of the outer element 4 remains non-transparent. The outer reflective surface of the outer element 4 of the cover causes a reflection of light, thus increasing the effect of the light coming from the showerhead.

The lever 9 is used to turn the components 4 and 10 jointly relative to the component 16 and thereby to change a pattern of water issuing from the showerhead.

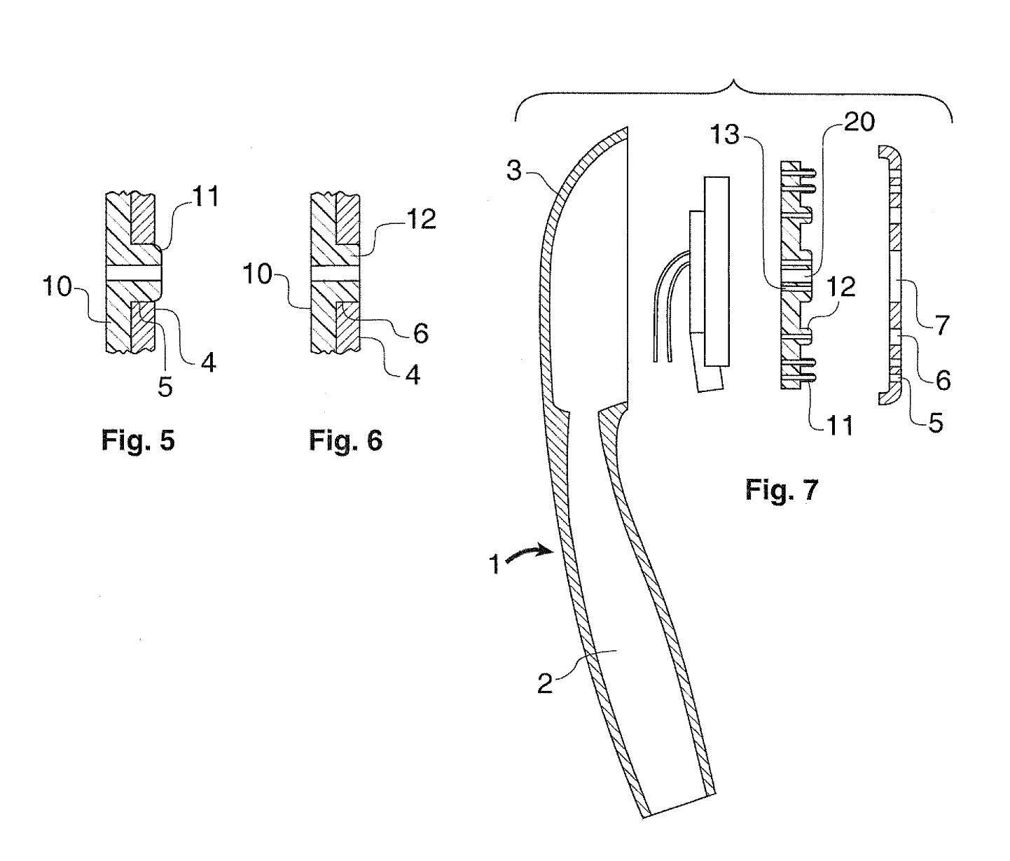

As shown in FIG. 5 the transparent hollow projections 11 of the inner element 10 of the cover extend outwardly beyond the outer element 4 of the cover and also are made flexible. With this construction a user can act on outwardly projecting sections of the transparent hollow projections 11 and slightly displace them transversely to dislodge possible accumulations of mineral residue from shower water on inner walls of the transparent hollow projections 11 and to clear their interior to facilitate the passage of water therethrough. In contrast the transparent hollow projections 12 which can have a greater inner diameter than the transparent hollow projections 11, can be made rigid.

The invention is not limited to the details shown since various modifications and structural changes are possible without departing from the spirit of the invention.

What is desired to be protected by Letters Patent is set forth in particular in the appended claims.

1. A showerhead, comprising a hollow housing connectable to a source of water;
a cover which covers said housing and is provided with a plurality of outlet openings through which water passing through said housing issues in form of water jets; a light source arranged in said housing and generating light, wherein said cover is provided with a plurality of local transparent portions at least some of which are each adjacent to at least one of said openings and separated from other transparent portion by non-transparent portions, so that the light generated by said light source exits said housing only through said transparent portions which are adjacent to said outlet openings of said cover and thereby adjacent to the issuing water jets.

2. The showerhead as defined in claim 1, wherein each of said transparent portions of said cover is circular and circumferentially surround each of said outlet openings of said cover.

3. The showerhead as defined in claim 1, wherein said cover has an outer non-transparent element provided with a plurality of said openings and an inner element which is transparent and has a plurality of transparent hollow projections which are inserted into said openings of said outer element and form said local transparent portions.

4. The showerhead as defined in claim 2, wherein some of said transparent hollow projections of said inner element are flexible and extend outwardly beyond said outer element of said cover.

5. The showerhead as defined in claim 4, wherein other of said transparent hollow projections of said inner element are rigid.

6. The showerhead as defined in claim 1, wherein said cover has an outer surface which is light-reflective.
